(19) United States
(12) Patent Application Publication
(10) Pub. No.: US 2005/0154566 A1
(43) Pub. Date: Jul. 14, 2005

(54) System and method for designing fire systems

(76) Inventors: David R. Farrell, Dallas, TX (US); Brad Stroud, Plano, TX (US)

Correspondence Address: Michael L. Diaz;Michael L. Diaz, P.C., Suite 200, 555 Republic Drive, Plano, TX, 75074, US

(21) Appl. No.: 10/756,492

(22) Filed: Jan. 13, 2004

(51) Int. Cl. G06F 17/50

(52) U.S. Cl. 703/1

(57) ABSTRACT

A method and system for automatically designing fire systems for a specific building. The system includes a computing system and an input terminal for a designer to communicate with the computing system. The computing system also includes a graphics module for generating graphical representations of components of the fire system. The computing system also includes a database for storing data on components of the fire system. The designer, through the input terminal, selects specific components and locations of the components. The computing system then automatically gathers and calculates the fire alarm system data, to include riser diagrams, cost estimates, signaling diagrams, component specifications, bill of materials, voltage loss charts, battery back up calculations, submittal letters, table of contents and all other information required to be included within a formal submittal package to an authority having jurisdiction.

### BACKGROUND OF THE INVENTION

1. Technical Field of the Invention

This invention relates to designing fire protection and detection systems and, more particularly, to a system and method for designing fire systems.

2. Description of Related Art

In large buildings, it is imperative that adequate safety features are incorporated into the design and construction of the building. In particular, fire/smoke notification and suppression systems must also be designed in such a fashion as to provide critical life-saving functions to the people it houses. However, the design of such fire systems can be very complex. There are various types and models of devices commonly used in fire systems. Each device, such as sprinkler heads and detection sensors, have different properties which oftentimes change the configuration of the entire fire system. The properties of each device, which may affect the overall configuration of the system, may include the coverage of the device, amperage of the device, line-loss degradation versus length of lines, and battery requirements.

Typically, a plurality of devices are controlled by a panel located near the plurality of devices. The devices are connected to the panel by circuits providing signaling and electric power from the panel to the plurality of devices. The circuits and devices are usually located on or near the ceiling or walls of the building. However, each circuit must follow within established trays already built or designed within the building, thus limiting the routes of the circuits for each panel. Also, each panel is connected to a master control center which remotely controls and monitors the fire system. Adding to the complexity of the design of such fire systems are the administrative requirements instituted by various governmental agencies. Therefore, the design and presentation of such fire systems are very complex.

Currently, the design of these fire systems requires the selection of the various devices and the routes of the circuits leading from the devices to the panels and master control center. Additionally, the design must incorporate the device type and location, signal diagrams, riser diagrams, battery calculations, line-loss charts and other installation details within the plans. This design process is currently conducted manually. Therefore, when a component or its location is modified, the entire design must also be changed. This existing design process is tedious and labor intensive. A system and method are needed which, upon selection and location of the devices, panels and master control center, automatically calculates related system information for the fire system.

Thus, it would be a distinct advantage to have a system and method which automatically calculates fire system information for implementation in a specified building. It is an object of the present invention to provide such a system and method.

### SUMMARY OF THE INVENTION

In one aspect, the present invention is a system for designing a fire alarm system. The system includes a computing system and an input terminal communicating with the computing system. The input terminal allows a designer to provide a plurality of selections on a plurality of components and associated locations of the fire system. The computing system, from the data provided by the designer, generates a design plan for a fire system within a specified building.

In another embodiment of the present invention, the system is a system for designing a fire system. The system includes a computing system and a storage database communicating with the computing system. The storage database stores data on a plurality of components utilized in the fire system. In addition, the system includes an input terminal communicating with the computing system. The input terminal allows a designer of the fire system to select specific locations and components of the plurality of components for the fire system. The computing system then generates associated data of the fire system within a specified building. The computing system also provides a plurality of graphics representing the plurality of components of the fire system. The design plan includes a progressive cost estimate for installing the fire system.

In another aspect, the present invention is a method of automating the design of a fire system for a specified building. The method begins by inputting building data on the specified building to a computing system. Next, data is inputted on a plurality of components of the fire system to the computing system. All associated data related to control equipment and field components is automatically inputted into appropriate databases for future retrieval.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a fire system for a specified building;

FIG. 2 is a simplified block diagram illustrating the components of a design system for the fire system in the preferred embodiment of the present invention; and

FIGS. 3A-3B are flow charts outlining the steps for designing the fire system by utilizing the design system according to the teachings of the present invention.

### DETAILED DESCRIPTION OF EMBODIMENTS

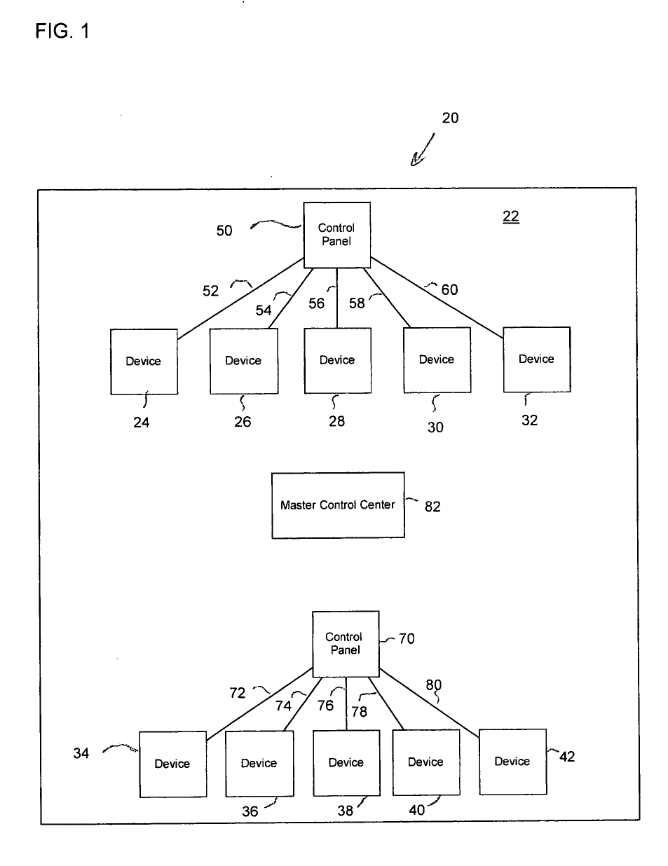

The present invention is a system and method for automatically calculating system data for fire systems for a specified building. FIG. 1 is a simplified block diagram illustrating the components of a fire system 20 for a specified building 22. The system includes a plurality of devices 24, 26, 28, 30, 32, 34, 36, 38, 40, and 42. The devices 24,26, 28, 30, and 32 are connected to a control panel 50 by circuits 52, 54, 56, 58, and 60. The devices 34, 36, 38, 40, and 42 are connected to a control panel 70 by circuits 72, 74, 76, 78, and 80. The control panels 50 and 70 are connected to the master control center 82. The fire system 20 may include any number and configuration of components and is reduced to the above discussed configuration for simplicity. It should be understood to those skilled in designing fire systems that the disclosed invention may be used with any fire system.

The devices may include manual alert mechanisms/devices, fire detection apparatuses, such as smoke detectors and/or thermal sensors. Other devices may include sprinkler system monitor modules for the detection of any suppression release. As discussed above, there are various manufacturers of the devices with each specific device having specific requirements and properties. The properties may include the coverage of the device which may be dependent upon the location of the device. For example, the height of the ceiling for which the device is located may change the coverage of the particular device. Additionally, a specific “relay need” notification may be determined. The circuits must follow within cable trays, conduits, or routing areas typically already designed or built into the construction of the building. Thus, the layout of the lines must follow these routes/paths to each device.

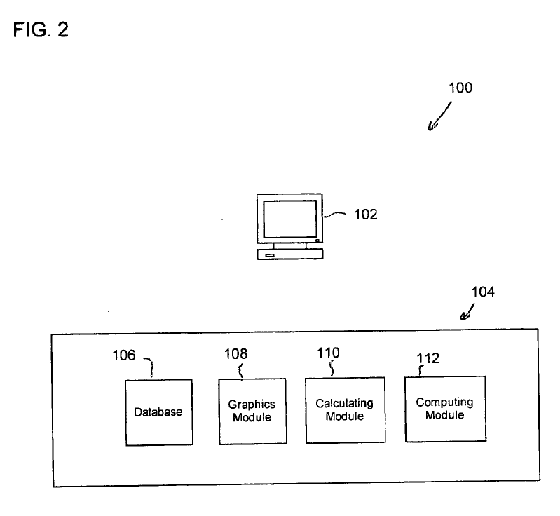

FIG. 2 is a simplified block diagram illustrating the components of a design system 100 in the preferred embodiment of the present invention. The design system includes an input terminal 102 connected to a computing system 104. The computing system includes a database 106, a graphics module 108, a calculating module 110, and a computing module 112.

The database 106 stores component data on various components or devices, such as names of manufacturers, cost of devices, component requirements, device signal names, coverage, current draw, line loss, backup capability, circuit load, and other data associated with each device. The database may also contain graphical representations/labels associating the components with the devices, control panels, signal lines, and master control center. A portion of this data may vary with other factors, thus stored tables or formulas may be required for the determination of the properties of the devices, control panels, master control center, and lines. The input terminal 102 provides a designer the ability to input data and selections to the computing system 104. For example, the designer may provide additional data on a device. In addition, the designer selects the specific device and location within the building 22. The input terminal may be any device allowing communication with the computing system 104. In the preferred embodiment of the present invention, the input terminal is a conventional computer terminal.

The computing system 104 provides the computations and automatic functions necessary for creating the finished design/plans/calculations of the fire system 20. The computing system receives inputs from the designer via the input terminal 102. The computing system stores all relevant data within the database 106. The graphics module 108 enables the computing system 104 to provide graphical representations to the designer, such as conventional signaling diagrams, electrical schematics, riser diagrams, and graphical depictions of the components of the fire system. The calculating module 110 provides calculating functions for the determination of circuit data, device data, and the cost of the fire system 20. As various components of the fire system are modified, the cost may also be automatically modified. The computing module 112 provides computations on the relevant components, placement of the circuits with inputted cable path locations, battery calculations, voltage loss calculations, bill of materials, etc. The database, graphics module, calculating module, and computing module may reside within the computing system or separately from the computing system.

With reference to FIGS. 1 and 2, the operation of the design system 100 will now be explained. Prior to implementation of the design system 20, the designer inputs data for the various component (e.g., devices, control panels, etc.). The data may include manufacturer, cost, coverage, battery, signaling requirements and any other data necessary for the implementation of any fire system. Additionally, cable path height/position, ceiling height, and device height is inputted into the computing system. The received data is stored within the database 106 through input by the designer via the input terminal 102.

The designer provides data on the building 22 through the input terminal to the computing system 104. The data is stored within the database 106. Additionally, the graphics module 108 may provide a diagram of the building for display to the designer through the input terminal 102. For example, a plan form view of the building may be displayed to the designer. The designer also selects the desired devices, control panels, and locations of each component within the building 22. For ease of selection, icons may be used to symbolically represent the components for which the desired may drag and drop or insert to the appropriate places on the depiction of the building. As the designer positions the icons representing the components of the fire system 20 within the building, the computing system through the computing module 112 continuous calculates the circuit length, voltage loss, circuit placement, etc. Additionally, the computing system, from the calculations derived from the computing module 112, creates riser and signaling diagrams through the graphics module 108. This information may be progressively generated for display to the designer.

Once all data is inputted within the computing system 104, including device selection and location, the computing system determines the appropriate signal names. The placement of the signal information on the diagrams is then selected by the designer. The computing system may optionally prompt the designer for selection of the signal information.

The computing system 104, through the computing module 112, determines the appropriate data from the inputted data. For example, riser diagrams, cost estimates, signaling diagrams, component specifications, bill of materials, voltage loss charts, battery back up calculations, submittal letters, table of contents and all other information required to be included within a formal submittal package to an authority having jurisdiction are created by the computing system. Additionally, device cut sheets/specifications may optionally be generated to the designer. These specifications may be stored within the database 106 or via interaction with a network (e.g., via the Internet) to a central remote repository of such information (not shown).

Thus, fire alarm systems data is automatically created by the design system 100. The designer provides the appropriate data about the building, cable path location, and desired type and location of the components of the fire system 20. The design system then automatically creates the appropriate information in a standardized format necessary for design of the fire system 20.

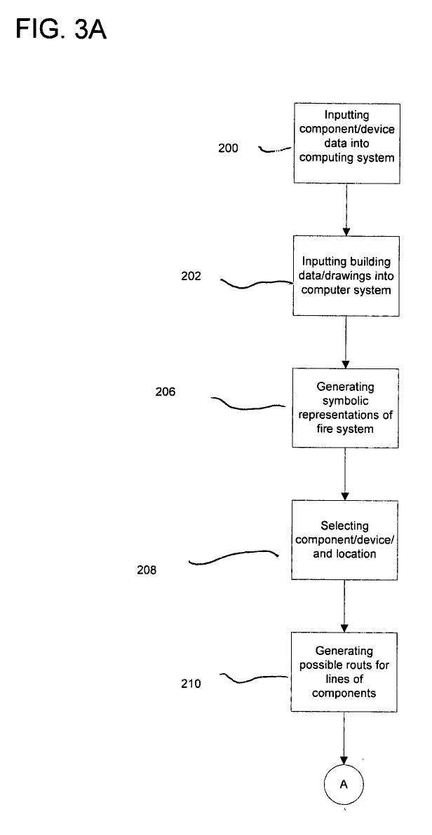

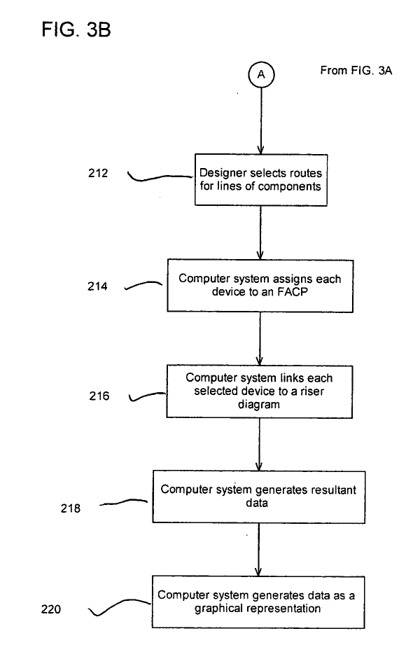

FIGS. 3A-3B are flow charts outlining the steps for designing the fire system 20 by utilizing the design system 100 according to the teachings of the present invention. With reference to FIGS. 1, 2, 3A and 3B, the steps of the method will now be explained. The method begins with step 200, where the data is inputted into the computing system 104 and stored within the database 106. The data may include relevant information on various types of devices and components of one or more fire system. For example, the component's manufacturer, cost of the component, associated requirements, coverage of the component, battery and signaling requirements may all be stored within the database. Next, in step 202, the designer inputs data about the building 22 into the computing system. For example, cable path height and position, ceiling height, and device height is inputted into the computing system. The data is inputted by the designer through the input terminal 102 communicating with the computing system 104.

In step 206, the computing system 104 creates a symbolic representation of the building 22 and provides icons representing the various components of the fire system. Next, in step 208, the designer selects the appropriate component/device (represented by an icon) and location of the component/device. In the preferred embodiment of the present invention, the designer moves a selected icon to a desired location depicted on the building graphical representation. In step 208, the computing system calculates coverage areas for the components and, through the graphics module 108, optionally generates coverage clouds, colors, ceiling height dependency depicted on the building diagram. Preferably, the coverage clouds are presented in layer format in which each component (device) includes an associated coverage cloud. Thus, one or more layers representing one or more devices may be selectively presented to the designer.

Next, in step 210, the designer calculates one or more routes for the lines leading to and from the devices/components. As discussed above, the routes are limited to the cable paths designed by the designer. In step 212, the designer selects the route from the selections provided by the computing system.

Next, in step 214, the computing system 104 assigns each selected device to an FACP (Fire Alarm Control Panel). The method continues with step 216 where the computing system links each selected device to a riser diagram through the graphics module 108. In step 218, the computing system generates resultant data for use by the designer associated with the fire system design. For example, submittal letters, estimate spreadsheets, battery calculations, voltage loss spreadsheets, and bills of material may automatically be created. This resultant data may be generated at any point during the process for providing progressive updates to the fire system design. Additionally, in step 220, the computing system, through the graphics module, generates graphical representations for all relevant resultant data. For example, riser diagrams and device cut-sheets/specifications are generated. The method provides for automatic calculation of designing fire system data and associated plans through the input of selected data to the computing system. The method provides the requisite completed reports including any diagrams necessary for building the fire system 20 and submitting the design to a governmental authority having jurisdiction.

In an alternate embodiment of the present invention, the specifications of the various components of the fire system 20 may be stored in a remote database (not shown). The designer may periodically update the database 106 from the remote database for current information. The communication of the computing system 104 to the remote database may be by any communications link, such as via the Internet.

The design system and method provides many advantages over existing products. The design system enables a designer to automatically create resultant data from data inputted from the designer. Specifically, the system provides riser diagrams, signaling diagrams, submittal letters, estimate spreadsheets, battery calculations, voltage loss spreadsheets and bills of material necessary in installing a design system to a customer, as well as any data required by governmental agencies. The disclosed invention allows the information to be automatically created with the ability to modify the resultant data as necessary.

It is thus believed that the operation and construction of the present invention will be apparent from the foregoing description. While the method and system shown and described have been characterized as being preferred, it will be readily apparent that various changes and modifications could be made therein without departing from the scope of the invention as defined in the following claims.

1. A system for designing a fire system, said system comprising:
a computing system; and
an input terminal communicating with said computing system, said input terminal allowing a designer to provide a plurality of selections on a plurality of components and associated locations of the fire system;
said computing system having means for generating design data for a fire system within a specified building.

2. The system for designing a fire system of claim 1 wherein the means for generating design data includes generating a riser diagram illustrating a plurality of components of the fire system.

3. The system for designing a fire system of claim 1 wherein the means for generating design data includes generating a plurality of graphics representing a plurality of components of the fire system.

4. The system for designing a fire system of claim 1 wherein the means for generating design data includes calculating a progressive estimate of costs associated with the fire system.

5. The system for designing a fire system of claim 1 wherein the means for generating design data includes generating a plurality of routes linking a plurality of components of the fire system together, said plurality of routes providing a plurality of choices for linking the plurality of components.

6. The system for designing a fire system of claim 1 wherein the means for generating design data includes generating a plurality of requirements of a plurality of components utilized in the fire system.

7. The system for designing a fire system of claim 1 wherein the design data includes signaling diagrams illustrating a plurality of components of the fire system and the plurality of components signaling schematics.

8. The system for designing a fire system of claim 1 further comprising a storage database communicating with the computing system, said storage database storing data on a plurality of components utilized in the fire system.

9. A system for designing a fire system, said system comprising:
a computing system;
a storage database communicating with the computing system, said storage database storing data on a plurality of components utilized in the fire system; and
an input terminal communicating with said computing system, said input terminal allowing a designer of the fire system to select specific locations and components of the plurality of components of the fire system;
said computing system having means for generating design data for the fire system within a specified building, said generating means providing a plurality of graphics representing the plurality of components of the fire system;
said design data providing a progressive cost estimate of installing the fire system.

10. A method of automatically designing a fire system for a specified building, said method comprising the steps of:
inputting building data on the specified building to a computing system;
inputting data on a plurality of components of the fire system to the computing system; and
generating a design of the fire system for a specified building.

11. The method of automatically designing a fire system of claim 10 wherein the step of inputting data on a plurality of components includes selecting a type and location for each component of the fire system.

12. The method of automatically designing a fire system of claim 10 further comprising, after the step of inputting data on a plurality of components, the step of generating a plurality of possible routes of circuits communicating between the plurality of components of the fire system.

13. The method of automatically designing a fire system of claim 12 further comprising, after the step of generating a plurality of possible routes of circuits communicating between the plurality of components of the fire system, the step of selecting a route from a plurality of possible routes.

14. The method of automatically designing a fire system of claim 10 wherein the step of generating a design of the fire system for a specified building includes providing a graphical representation of the fire system.

15. The method of automatically designing a fire system of claim 10 wherein the step of generating a design of the fire system includes generating signaling diagrams of the plurality of components of the fire system.
